(19) United States
(12) Patent Application Publication
(10) Pub. No.: US 2023/0080596 A1
(43) Pub. Date: Mar. 16, 2023

(54) CAPTURING, RELIVING AND REMAKING MEMORY EXPERIENCE

(71) Applicant: Sujatha Sundaravaradan, Rancho Palos Verdes, CA (US)

(72) Inventor: Sujatha Sundaravaradan, Rancho Palos Verdes, CA (US)

(21) Appl. No.: 17/941,084

(22) Filed: Sep. 9, 2022

Related U.S. Application Data
(60) Provisional application No. 63/243,176, filed on Sep. 12, 2021.

(51) Int. Cl. G06F 16/535; G06F 16/58

(52) U.S. Cl. CPC G06F 16/535; G06F 16/58

(57) ABSTRACT

Aspects of the disclosure are directed to memory experience. In accordance with one aspect, an apparatus and method for experiencing a memory includes capturing the memory in a plurality of visual images; tagging the memory with one or more tags, wherein the one or more tags include a situation, an emotion, a smell, a touch or a sound; storing the memory in a database; inputting a query to recall the memory from the database; displaying a result associated with the query, wherein the result is a list of at least one event based on the query, and wherein each of the at least one event comprises at least one of the plurality of visual images.

### CLAIM OF PRIORITY UNDER 35 U.S.C. § 119

The present Application for Patent claims priority to Provisional Application No. 63/243,176 entitled “CAPTURING AND RELIVING MEMORY EXPERIENCE” filed Sep. 12, 2021 by the same inventor, hereof and hereby, expressly incorporated by reference herein.

### TECHNICAL FIELD

This disclosure relates generally to the field of memory experience, and, in particular, to capturing, reliving and remaking memory experience.

### BACKGROUND

It is good to have a special space that grows with you in the ever-expansive virtual world. Forget about buying a star in your name or your child's name. What if you can create a world for yourself with just your memories. Those memories do not have to simply stay in your mind or in haphazard photo albums or in that infamous cloud. Instead, they can be experienced.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method for experiencing a memory, the method includes: using a camera configured for capturing the memory in a plurality of visual images; tagging the memory with one or more tags, wherein the one or more tags include a situation, an emotion, a smell, a touch or a sound; storing the memory with the one or more tags in a database; inputting a query to recall the memory with the one or more tags from the database; and displaying a first result associated with the query, wherein the first result is a list of at least one event based on the query, and wherein each of the at least one event includes at least one of the plurality of visual images.

In one example, the first result is displayed in a virtual 3-dimensional (3D) space that is projected onto a real space setting where a user is present. In one example, the method further includes refining the query to generate a second result. In one example, the method further includes using a screen configured for displaying the second result. In one example, the method further includes displaying the second result to replace the first result in the virtual 3-dimensional (3D) space. In one example, the method further includes injecting one or more interactions into the first result. In one example, the one or more interactions include one or more of: dialogue, music, character, or a modification to the virtual 3D space.

In one example, the method further includes remaking the memory by one or more of the following:
(a) replacing a venue associated with one of the plurality of visual images;
(b) aging a character associated with one of the plurality of visual images;
(c) specifying a time period for a geographical location associated with one of the plurality of visual images;
(d) adding a character to one of the plurality of visual images;
(e) replacing a character with a different character to one of the plurality of visual images; or
(f) changing the one or more tags.

In one example, the first result is displayed in a virtual 3-dimensional (3D) space that is projected onto a real space setting where a user is present. In one example, a projection of the virtual 3D space surrounds the user. In one example, the method further includes refining the query to generate a second result. In one example, the method further includes displaying the second result to replace the first result in the virtual 3-dimensional (3D) space. In one example, a projection of the virtual 3D space displays in a conveyor belt fashion in front of the user. In one example, the method further includes refining the query to generate a second result. In one example, the method further includes displaying the second result to replace the first result in the virtual 3-dimensional (3D) space.

Another aspect of the disclosure provides an apparatus for experiencing a memory, the apparatus includes: a camera configured for capturing the memory in a plurality of visual images; a processor coupled to the camera, the processor configured for tagging the memory with one or more tags, wherein the one or more tags include a situation, an emotion, a smell, a touch or a sound; a storage unit coupled to the processor, the storage unit configured for storing the memory with the one or more tags; and a keyboard coupled to the processor, the keyboard for inputting a query to recall the memory from the storage unit.

In one example, the apparatus further includes a screen configured for displaying a result associated with the query, wherein the result is a list of at least one event based on the query, and wherein each of the at least one event includes at least one of the plurality of visual images. In one example, the apparatus further includes an output configured for projecting a result associated with the query, wherein the result is projected as a virtual 3-dimensional (3D) space onto a real space setting where a user is present.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example 100 for experiencing a memory.

FIG. 2 illustrates an example overview in accordance with the disclosure herein.

FIG. 3 illustrates an example of the relive, witness and/or experience aspects in accordance with the disclosure herein.

FIG. 4 illustrates four example cases in accordance with the disclosure herein.

FIG. 5 illustrates an example of data for optimal experience collected during registration in accordance with the disclosure herein.

### DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

How many times has someone tried to “organize” photos and videos they have taken? Remember the “let's organize the photos/videos conversation”? Remember how the attempts to organize that did not go well? Remember the efforts for getting the latest, greatest, largest external hard disk to store all the photos/videos in the junk drawer? Remember using the “online photo albums” or other printing services?

In one example, a photo may be an analog photo, a digital photo, a drawing, and/or a painting, etc. Although the term “photo” is used in the present disclosure, it is being used to convey any static visual image.

In one example, a video may be an analog film, a movie, a collection of photos presented in a continuum, a recording of images and/or a collection of digital images, etc. Although the term “video” is used in the present disclosure, it is being used to convey any dynamic visual image. In one aspect, a static visual image or a dynamic visual image may include associated audio and/or associated textual information (i.e., text).

These efforts may have been exciting for a while, but eventually they get tiresome because of all the efforts needed for uploading, creating and printing the albums. Additionally, there are only so many prints/videos to order while the rest stay as online albums never to see the light of the day. Even to an organized person (perhaps with a photo mug on the desk), the bottom line is that those are still only 2D albums and videos.

Metaphysics says there is no past, there is no present and there is no future in a sense and there is only one moment and now is it. Perhaps, we all live in different universes and what we see as a unified universe is an illusion on some level. However, one can create one's personal universe by capturing the memories and then reliving the moments that are artistically captured with photos and videos. Additionally, one's personal universe may include remaking the captured memory to create additional memories.

There are three processes disclosed herein: 1) Capturing the Memory; 2) Reliving the Memory and 3) Remaking the Memory.

In “Capturing the Memory”, take one or more photos and/or videos using, for example, cameras on smart phones or smart devices (e.g., a tablet, a computer, etc.). One skilled in the art would know that photos and/videos can also be taken by stand-alone cameras for photos and/or videos. Once the photos and/or videos are taken, they are stored, for example, in a database. For example, the storage of the photos/videos may be in a hard drive associated with a camera, a smart phone, a smart device, etc., or in an external storage unit or in a cloud, etc. In one example, the photo(s) and/or video(s) is a memory that has been captured.

The photos/videos taken can be tagged. In one example, the person taking the photo/video chooses one or more tags for the photo/video. Some examples of tags may include the following: date, time, location, situation, emotion, smell, touch (feel) and/or sound. One skilled in the art would understand that the tags listed here are examples and are not exclusive, such that other tags may be used within the scope and spirit of the application. In one example, an application software on a processor may recommend one or more tags for each photo/video. In one example, the recommendation may be based on the photo/video taker's appearance. In one example, the tags may be presented via animation or emoji. In one example, the tags may be associated with an apparatus for dispensing a fragrance (e.g., a perfume spray device, a scent dispenser, etc.). In one example, the tags may be associated with an apparatus for playing music and/or sound (e.g., a radio, a music player, an audio player, etc.) to express a particular emotion and/or situation. In one example, a particular sound or music may cause a particular feeling of touch to a user. In one example, the tags may be associated with an apparatus that may play music, sound and/or dialogue, and/or may dispense a particular smell or scent.

In one example, the photos/videos (along with its tag(s)) are stored in a database. The database can be cloud based or a hardware storage unit.

In “Reliving the Memory”, a user inputs a query to recall a memory, for example, from the database. The query can be a word, a phrase or a sentence. It could also be different words connected by a connector such as “and”, “or”, etc. An example of a query is “find an example of me with friends”. An example result may include the following events:
Event 1: Mexico Beach vacation, 2019
Event 2: Utah Ski trip 2020
Event 3: Girlfriend outing 2018
Event 4: Friend Liz's 30^{th} birthday, 2020
   In one example, the result is displayed in a screen. The screen may be a component of a smart device (e.g., a smart phone, a smart tablet, a computer).

In one example, the result (with the 4 events) may be displayed in a “hallway of memory” with each of the events being displayed. In one example, the “hallway of memory” is a virtual 3-dimensional (3D) space that is projected onto a real space setting where a user is present. In one example, the projection of the virtual 3D space surrounds the user. In one example, the projection of the virtual 3D space displays the result in a conveyor belt fashion in front of the user.

In one example, the user may choose static displays of each event. In another example, the user may choose a dynamic display of each event, wherein the display would include any associated tag(s) with each photo/video within the event. Multiple display instructions may be presented by a user. For example, the user may instruct a) “display each event only as static photos”; b) “display each event with only photos/videos in the event having a particular tag”; etc.

Once the photos/videos that fit the query is found, the user may refine the results by modifying the query. From the earlier example, the query may be refined as “find an example of me with friends that include a beach scene”. Thus, the example would result in the following events:
Event 1: Mexico Beach vacation, 2019
Event 3: Girlfriend outing 2018
Event 4: Friend Liz's 30^{th} birthday, 2020
   Note that the refined result no longer includes Event 2.

Further refinement may be added to the query, such as: “find an example of me with friends that include a beach scene in 2019”. In this refinement, only Event 1 would be displayed.

In one example, a query may include a non-occurrence. For example, a query may be “find an example of me with friends but not in 2018”. Given this query, the results would be Event 1, 2 and 4, but not Event 3.

In one aspect, “Reliving the Memory” may include a Viewing Option and/or an Experiencing Option. In one example, in the Viewing Option, the following may occur: on selecting the Viewing Option for a set of photos/videos picked, the user may experience a virtual selected space (e.g., a virtual 3-dimensional (3D) space such as a home setting, an interior setting, an outdoor setting, a vacation setting, a favorite movie scene, etc.) and settles on a couch and the point of view (POV) changes. The user may watch a “movie” of all the photos/videos while the user also experiences being surrounded in its virtual selected space. The “movie” may even include commercial breaks and/or virtual snacks. That is, commercial breaks and/or virtual snacks may be injected by the user into the “movie”. In one example, “inject” means to add to the “movie”.

In addition to the Viewing Option, the user may add an Experiencing Option. In the Experiencing Option, the user injects one or more interactions into the “movie”. In one example, the “movie” is the result of the query. For example, the one or more interactions may include: dialogue, music, additional characters, modification(s) to the virtual selected space. Examples of modification(s) to the virtual selected space may include, but is not limited to, adding furniture to the virtual space, changing colors or lightings in the virtual space, changing the look and/or arrangement of the virtual space, etc. In one example, the one or more interactions may be stored in a database for the user to recall and use in the Experiencing Option by injecting it into the “movie”.

In another example, the one or more interactions for use in the Experiencing Options may be injected by the user into the “movie” in real time. For example, as the user is viewing the “movie”, if there's a baby crying in real time, the user can inject the baby's crying into the “movie” as part of the Experiencing Option. “Injecting” in this context means to add. That is, In one example, the user may add the crying sound of the baby into the “movie”. In another example, the user may add a visual image of a crying baby into the “movie”. In yet another example, the user may a visual image of a crying baby along with the audio sound of the baby crying into the “movie”.

In “Remaking the Memory”, a user may select a photo or a video. In another example, the user may select the photos/videos in an entire event. The location of where the photo/video was taken is identified. In an example, the location may be replaced with a more current photo of the location. In one aspect, the user may specify a time period for the location. For example, the selected photo/video may be taken in 1980. The user may specify that the location replacement be at a time period between 1980 and the present, or the user may specify that the location replacement be at the present time. In one example, a location is a venue. In one example, a location is a geographical area.

In one example, the user may replace and/or add a character into the photo/video. The added character could be another person, an animal and/or an object. In one example, the user may specify a photo of another character from the user's database. In the example where the character is a public character, the photo of the public character could be from another database different from the user's database.

In one example, the user may replace a character (people, animal or object) in the photo, video or event with the same character (people, animal or object) except with added aging. For example, a person who was at age 5 in the photo, video or event is replaced with the same person now at an older age. An available image of the person at the older age may replace the image of the person at age 5 in the photo, throughout the video or throughout the event. In one example, the image of the person at the older age is an existing image in a database. In another example, the image of the person at the older age is created using available aging software/program to extrapolate an image of the person at the older age. One skilled in the art would understand that replacement of a character is not limited to being based on age, but could be based on other conditions, such as a new or change in look or appearance, a change in clothes, a change in scenery, a change in the time of day, a change in scent or smell associated with the character. For example, the user may replace an animal (e.g., a pig) with a different scent each time the animal (e.g., pig) appears in the photo, video or event. For example, the pig may smell like hay, but with Remaking the Memory, the pig now smells like prairie flowers.

In one example, during the remake, the user may add additional audio to be associated with the photo/video. Examples of the audio could include one or more of the following: narratives, conversation, music, other sounds, etc. In one example, during the remake, the user may add and/or remove tags.

Once the user decides that the remake is done, the user may store the replacement photo/video as part of an event, as its own event and/or a newer version of an event.

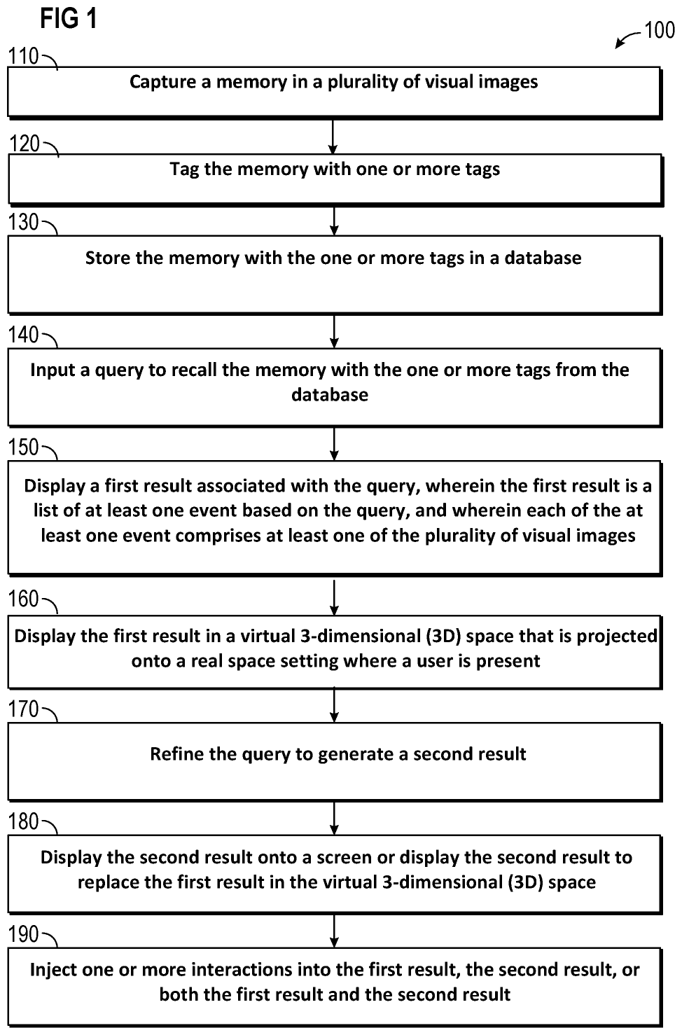

FIG. 1 illustrates an example 100 for experiencing a memory. In block 110, capture the memory in a plurality of visual images. In block 120, tag the memory with one or more tags, wherein the one or more tags include a situation, an emotion, a smell, a touch or a sound. In block 130, store the memory with the one or more tags in a database. In block 140, input a query to recall the memory with the one or more tags from the database. In block 150, display a first result associated with the query, wherein the first result is a list of at least one event based on the query, and wherein each of the at least one event comprises at least one of the plurality of visual images. In block 160, display the first result in a virtual 3-dimensional (3D) space that is projected onto a real space setting where a user is present. In block 170, refine the query to generate a second result. In block 180 display the second result onto a screen or display the second result to replace the first result in the virtual 3-dimensional (3D) space. In block 190, inject one or more interactions into the first result, the second result, or both the first result and the second result.

In one aspect, additionally, a special space that grows with you in the ever-expansive virtual world. Forget about buying a star in your name (or your child's name). Now you can create a world for yourself with just your memories. Those memories do not have to simply stay in your mind or in haphazard photo albums or in that infamous cloud. How many times have you tried to “organize”. Remember the let's organize the photos conversation you had with your loved ones? Yes, that did not go well. Then you patted yourself on your back for getting the latest, greatest and the largest external hard disk when you stored all your photos that ended up like the “junk drawer” in your home. Then you started using the “online photo albums” printing services. Those were exciting for a while and eventually they get tiresome because there is this little part of uploading, creating and printing the albums. There are only so many prints you want to order and the rest stay as online albums never to see the light of the day. Finally, even if you are the World's #1 organized person (with a mug on your desk) bottom line is those are still only 2D albums and videos.

All the phones now have top class cameras and geo location abilities. Time/date stamp have been a feature for decades. The photos can be arranged in various ways chronologically, location wise etc. Then we go ahead and throw some of these memories at a hard drive or “cloud” or print some. Don't you have the need to store them all in one place and most importantly relive them? When I say relive I mean really relive not stare at your screen and go “aww”. You created that fleeting moment in time and space. You captured it. You recorded that. In the world of disappearing texts and photos YOU want to record and relive those moments.

Metaphysics says there is no past, there is no present and there is no future in a sense and there is only one moment and this one. You do create your own universe and that is in your mind. We all live in different universes and what we see as a unified universe is an illusion on some level.

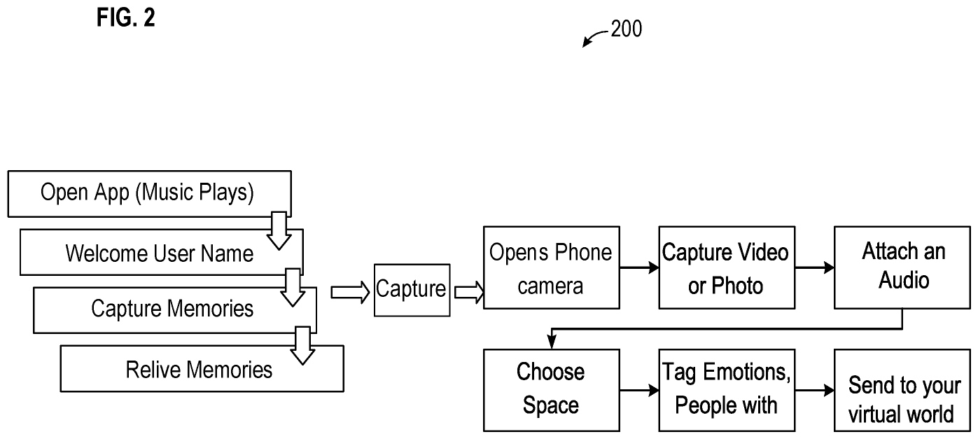

Come let's go and record and relive those moments you artistically captured. We will show you the way to create your world with all the good, bad and the ugly or just the good. FIG. 2 illustrates an example overview 200 in accordance with the disclosure herein.

What does our world do? The User transfers captured moments (photos and videos) into memories to relive and thereby create his/her own universe. Photos and videos are sent to their personalized universes where they settle in different spaces and times.

Data collected during registration. User uploads a photo and the software animates it. User records his/her voice using a variety of sentences.

Avatar Animation. User Uploads a full front high-resolution picture. Software animates the photo. In one example, more than one photo is animated. The avatar is presented up-close to the screen of the user and the user is prompted for, for example, a 10 second eye contact and visualization. Avatar turns around while zooming out and walks into the screen. After registration user is presented with 2 options: Capture Memories and Relive Memories. In one example, an avatar is a manifestation of an icon to represent a particular person or animal.

Capture Memories. This option opens the camera. Click the picture, tag locations, tag emotions, attach an audio, choose space and sub spaces and send it to personal universe.

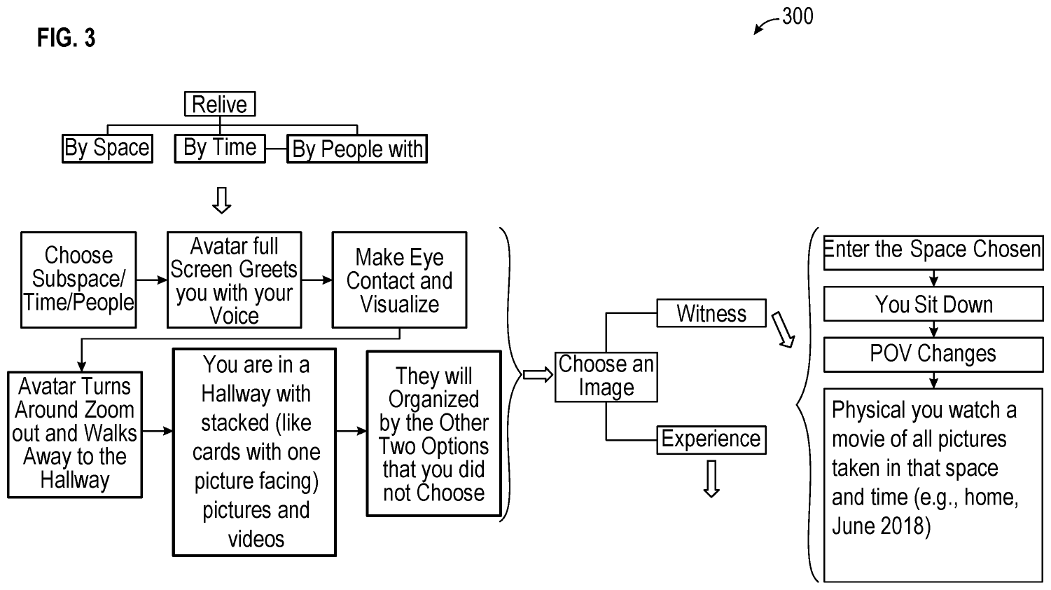

FIG. 3 illustrates an example 300 of the relive, witness and/or experience aspects in accordance with the disclosure herein. Relive Memories. On clicking “Relive memories” user is presented with various options. Relive by space, time, people, emotions. On selection, you enter the “Hallway of your universe” (The Great Hallway). In the hallway all the memories are stacked like cards with one memory/card facing you. Each stack is organized by the other two options the user did not choose. For example, if user choses “Relive by space” the memories are stacked by time, people and emotions. Users picks a stack (e.g., Home and further chooses 2018 and can filter down to a smaller time frame as well). Once a stack is chosen, the user can either . . . . Witness or Experience.

Witness Option. In all witness option, the following happens. On selecting the witness option for the stack picked, user enters the space (in this case a home setting) and settles on a couch and the point of view (POV) changes. Physical user will be watching a “movie” of all the images under 2018 home with even a commercial break in between with virtual snacks.

Experience Option. Under the “Experience” option the user can have more interaction with the chosen memory and make if even more meaningful.

Relive by Space (location). Witness. All of the user's memories by the selected space will appear. You can further filter by time, connections and emotions if need be. An appropriate themed music will play while the user witnessing all the memories related to that space. Eg—all memories related to a sports field will play with a relevant yet optional BG music.

Experience. A door opening sound is heard. If it is an outdoor image, the app reads the geo location on the original picture and pulls the actual location image from satellite imagery. The Virtual user is dropped in an actual image of the same location as in the original picture and placing the user in the same spot. If there are other people in the original picture and if they are in the user's trust circle (definition below), their animated versions are already there in the picture.

During registration the user records his/her voice. In that location after he/she appears, an Al generated conversation line (using the user's voice) will appear as an audio. Based on the time stamp of the original picture and the current date, the user's conversation line is adjusted. Example, “I can't believe I'm back here after 5 years”. Once you enter that memory, you can also have an option to place a call with friends already there to relive that shared experience.

Once you locate a memory (in this case a video) that you want to interact with/relive that memory, you tap it. The app makes a door opening sound and you enter that picture/video. If it is a memory stored as a video once the user enters the POV changes from third person to first person. Your image in the video will be removed from the video the POV changes. It will appear on the screen that physical you is interacting with the other person in the video.

Following the above process of witnessing and experiencing, the other three time, connections and emotions also operate.

Relive by Time (age). Witness—All of the user's memories by his/her age will appear. User can also use a particular year or even a decade. Eg—the user is 40 years old and clicks on “relive the 90's.

Relive by connections (people). User's memories connected to a chosen person will appear.

Relive by emotions/highlights. Every memory can be tagged by an emotion and further tagged as positive or negative or “highlight of my life”. User can simply run a “relive my highlights” command. Emotion tags here are very extensive. A small sample is presented here. Milestone, breakthrough, breakup, life lesson, relationship fail, relationship success, proud parent moment, parenting fail, workplace award, recognition, highlight of my life, high, low, up, down, positive, negative, teachable moment, victory, trial, error.

Simply reliving by witnessing a simple “relive my lows/negative emotions” string can easily be a self-help method and therapeutic. When you witness yourself as a 3^{rd} person non-judgmentally you make new observations.

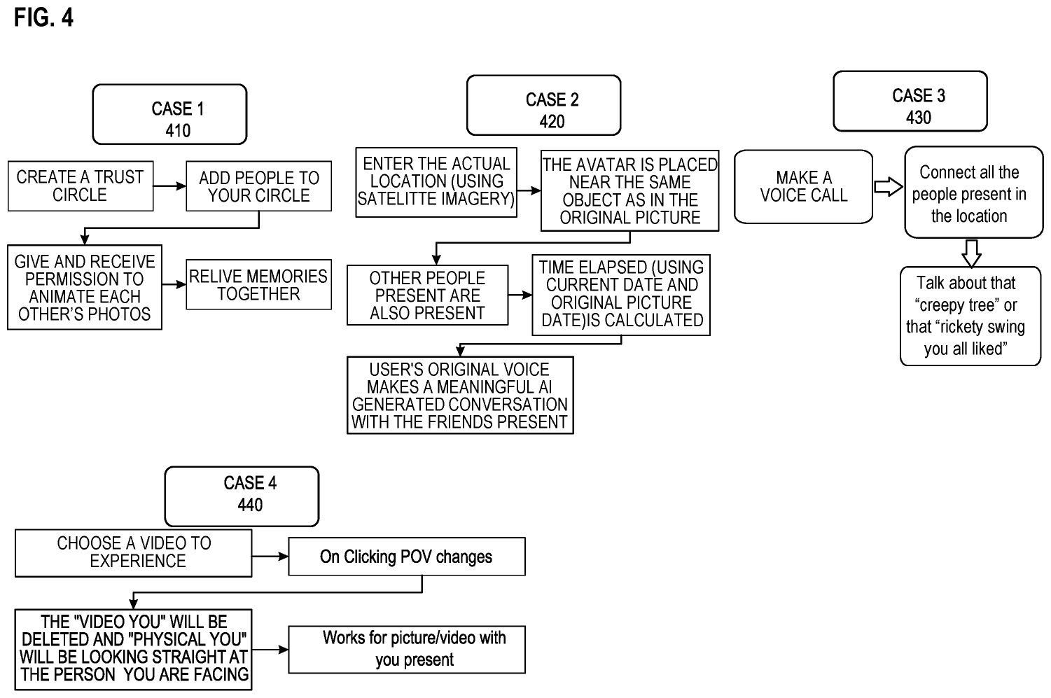

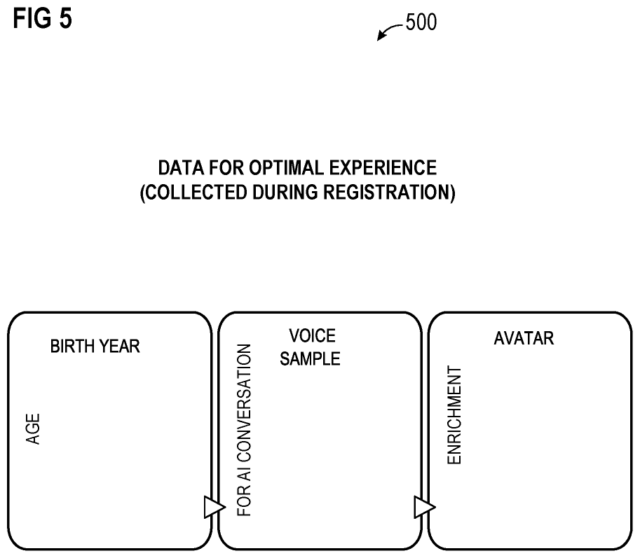

Creating a trust circle. As a user gets comfortable and familiar with the app, he/she can create a trust circle with other users/friends and give permissions to each other to use their animated versions in your universe. FIG. 4 illustrates four example cases 410, 420, 430, 440 in accordance with the disclosure herein. FIG. 5 illustrates an example 500 of data for optimal experience collected during registration in accordance with the disclosure herein.

In one aspect, one or more of the steps disclosed herein and in the figures may be executed by one or more processors which may include hardware, software, firmware, etc. In one aspect, the one or more of the steps may be executed by one or more processors which may include hardware, software, firmware, etc. The one or more processors, for example, may be used to execute software or firmware needed to perform the steps in the flow diagram(s) disclosed herein Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware for performing the present disclosure and the one or more steps in the figures. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. A method for experiencing a memory, the method comprises:
using a camera configured for capturing the memory in a plurality of visual images;
tagging the memory with one or more tags, wherein the one or more tags include a situation, an emotion, a smell, a touch or a sound;
storing the memory with the one or more tags in a database;
inputting a query to recall the memory with the one or more tags from the database; and
displaying a first result associated with the query, wherein the first result is a list of at least one event based on the query, and wherein each of the at least one event comprises at least one of the plurality of visual images.

2. The method of claim 1, wherein the first result is displayed in a virtual 3-dimensional (3D) space that is projected onto a real space setting where a user is present.

3. The method of claim 2, further comprising refining the query to generate a second result.

4. The method of claim 3, further comprising using a screen configured for displaying the second result.

5. The method of claim 3, further comprising displaying the second result to replace the first result in the virtual 3-dimensional (3D) space.

6. The method of claim 1, further comprising injecting one or more interactions into the first result.

7. The method of claim 6, wherein the one or more interactions include one or more of: dialogue, music, character, or a modification to the virtual 3D space.

8. The method of claim 1, further comprising remaking the memory by one or more of the following:
(a) replacing a venue associated with one of the plurality of visual images;
(b) aging a character associated with one of the plurality of visual images;
(c) specifying a time period for a geographical location associated with one of the plurality of visual images;
(d) adding a character to one of the plurality of visual images;
(e) replacing a character with a different character to one of the plurality of visual images; or
(f) changing the one or more tags.

9. The method of claim 8, wherein the first result is displayed in a virtual 3-dimensional (3D) space that is projected onto a real space setting where a user is present.

10. The method of claim 9, wherein a projection of the virtual 3D space surrounds the user.

11. The method of claim 10, further comprising refining the query to generate a second result.

12. The method of claim 11, further comprising displaying the second result to replace the first result in the virtual 3-dimensional (3D) space.

13. The method of claim 9, wherein a projection of the virtual 3D space displays in a conveyor belt fashion in front of the user.

14. The method of claim 13, further comprising refining the query to generate a second result.

15. The method of claim 14, further comprising displaying the second result to replace the first result in the virtual 3-dimensional (3D) space.

16. An apparatus for experiencing a memory, the apparatus comprises:
a camera configured for capturing the memory in a plurality of visual images;
a processor coupled to the camera, the processor configured for tagging the memory with one or more tags, wherein the one or more tags include a situation, an emotion, a smell, a touch or a sound;
a storage unit coupled to the processor, the storage unit configured for storing the memory with the one or more tags; and
a keyboard coupled to the processor, the keyboard for inputting a query to recall the memory from the storage unit.

17. The apparatus of claim 16, further comprising a screen configured for displaying a result associated with the query, wherein the result is a list of at least one event based on the query, and wherein each of the at least one event comprises at least one of the plurality of visual images.

18. The apparatus of claim 16, further comprising an output configured for projecting a result associated with the query, wherein the result is projected as a virtual 3-dimensional (3D) space onto a real space setting where a user is present.
